(19) United States
(12) Patent Application Publication
(10) Pub. No.: US 2022/0003300 A1
(43) Pub. Date: Jan. 6, 2022

(54) HYDRODYNAMIC TORQUE CONVERTER WITH A TORSIONAL DAMPER WALL

(71) Applicant: ZF Friedrichshafen AG, Friedrichshafen (DE)

(72) Inventors: Ewgeni BAYER, Sipplingen (DE); Ralf BECK, Oberteuringen (DE); Peter BRIELMAIER, Friedrichshafen (DE)

(21) Appl. No.: 17/366,799

(22) Filed: Jul. 2, 2021

(30) Foreign Application Priority Data
Jul. 3, 2020 (DE) 10 2020 208 352.5

(51) Int. Cl. F16H 45/02

(52) U.S. Cl. CPC F16H 45/02; F16H 2045/0226

(57) ABSTRACT

A hydrodynamic torque converter (1) with a bridging clutch (6) and with a torsion damper (8), and with a piston (7) and with an intermediate space (9) between the piston (7) and the torsion damper (8). The piston (7) serves to actuate the bridging clutch (6). The torsion damper has a torsion damper wall (85) via which hydraulic fluid, flowing into the intermediate space (9), is guided toward the bridging clutch (6).

This application claims priority from German patent application serial no. 10 2020 208 352.5 filed Jul. 3, 2020.

### FIELD OF THE INVENTION

The invention relates to a hydrodynamic torque converter with a torsion damper wall.

### BACKGROUND OF THE INVENTION

Hydrodynamic torque converters are clutches that work in accordance with the Fottinger principle. Due to their virtually wear-free mode of operation they are used in numerous technical fields for the transmission of rotational movements. The bridging clutch of the converter serves to enable the otherwise hydrodynamic coupling of the converter to be bypassed if necessary by a mechanical coupling. In that way flow losses in the converter can be minimized.

In automotive technology hydrodynamic torque converters are often used as a starting clutch and/or as an integral transmission shifting element. The torque converter is in that case provided as an input-side or a central shifting element of a multi-stage motor vehicle transmission. Thus, the torque converter is connected to the transmission by the action of torque. In the hydrodynamic operation of the torque converter, drive input power is transmitted by means of a hydraulic fluid. This takes place virtually without wear, so that it is the hydraulic fluid which predominantly absorbs the heat losses generated thereby. For that reason the torque converter is often connected to a cooling system of the transmission and/or the motor vehicle. Heat energy is produced in particular in the hydrodynamic torus of the converter and by friction work in the bridging clutch.

Hydrodynamic torque converters normally have a low-pressure side (suction side) and a high-pressure side (pressure side). In many transmission arrangements, for design reasons the feed line for hydraulic fluid to the converter cannot be arranged on the suction side of the latter and the return line for the hydraulic fluid from the converter cannot be arranged on its pressure side. The lines are then arranged elsewhere on the converter. Consequently heat can accumulate inside the converter and this can result in damage to temperature-sensitive converter components. Exceeding acceptable temperatures in the converter can also result in increased wear of the bridging clutch and deterioration of the hydraulic fluid.

From DE 10 2005 051 739 A1 a hydrodynamic torque converter with a bridging clutch and a torsion damper is known. The bridging clutch is intended to show constant behavior over a very long lifetime. For this, direct cooling of the clutch disks of the bridging clutch through an axial piston of the converter and the torsion damper is proposed.

From DE 20 2006 020 596 U1 a hydrodynamic torque converter with a bridging clutch and a damper is known. In this case the intention is to improve an oil flow over the friction surface of the disks of the bridging clutch in order to improve the cooling of the disks. For this, the circulating oil flow in the area of the hydrodynamic structural elements of the converter (pump, turbine, guide wheel) should still flow to and from the disks. For that purpose an additional wall is fitted on the side of the clutch piston that faces away from the piston pressure space.

DE 10 2007 005 999 A1 also discloses a hydrodynamic torque converter. In this case leakage flows that affect the cooling adversely and undesired friction effects are to be avoided. For that purpose a pressure chamber on the drive output side is delimited by the drive output side of the clutch piston and by a partition wall associated with the clutch piston. For its part, the partition wall acts between the pressure chamber on the drive output side and a cooling chamber.

### SUMMARY OF THE INVENTION

The purpose of the present invention is to improve upon the prior art. In particular, effective cooling of the bridging clutch of the torque converter should be enabled while keeping the production costs of the torque converter low.

This objective is achieved by the measures specified in the principal claim. Preferred embodiments thereof emerge from the subordinate claims.

According to these a hydrodynamic torque converter is proposed, which has a bridging clutch and a torsion damper and a piston. Between the piston and the torsion damper there is an intermediate space. The torque converter can transmit rotational movement from its input, hydrodynamically by means of a hydraulic fluid, to its output. Depending on the design and operating point of the converter, it is also possible that the converter increases the torque delivered on its output side compared with the torque applied on the input side.

The piston serves to actuate the bridging clutch. For this, the piston has in particular a pressure side that can be acted upon by a hydraulic pressure. Thereby, an actuating force is exerted by the piston on the bridging clutch. By reducing the hydraulic pressure the actuating force is reduced. In this way the clutch can optionally be closed and opened. When the bridging clutch is fully closed, the hydrodynamic power branch of the torque converter is bypassed (deactivated) in drive-technological terms, so that the torque on the input side is transmitted to the output of the converter via the bridging clutch. When the bridging clutch is fully open, only the hydrodynamic power branch of the converter is activated, so that a torque on the input side is transmitted purely hydrodynamically to the output. When a frictional bridging clutch is used, as in particular a disk clutch, intermediate settings between the fully open and fully closed clutch positions can also be produced, whereby the input-side torque is transmitted to the output of the converter partly by way of the bridging clutch and partly hydrodynamically.

The torsion damper serves to dampen torsion fluctuations between the input and output sides of the torsion damper, in particular due to non-uniform rotational behavior of an internal combustion engine on the input side. In that way torsion fluctuations applied on the input side are not passed on to the output side, or only so after being damped. The torsion damper is in particular connected into the power branch of the bridging clutch so that the torsion irregularities introduced by the bridging clutch are damped. It can be provided that the torsion damper does not act in the hydrodynamic power branch of the converter.

The torsion dampers conventionally used in torque converters are not designed to be an obstacle for hydraulic fluid. They have a multiplicity of passage openings through which the hydraulic fluid can pass. This applies particularly to the area of the damper where large window openings are provided in the damper for spring packs. Precisely there, hydraulic fluid can flow through the torsion damper almost without impediment in the axial direction.

In the torsion damper of the proposed torque converter a torsion damper wall is now provided. This has the effect that hydraulic fluid flowing into the intermediate space passes through the intermediate space to the bridging clutch. In that way, a bypass flow from the intermediate space which passes through the torsion damper while bypassing the bridging clutch is prevented or at least reduced to a sufficient extent. Thus, at least a large proportion of the hydraulic fluid entering the intermediate space in a targeted manner reaches the bridging clutch.

The torsion damper wall is suspended on the rest of the torsion damper. Thus, the torsion damper wall is supported by other structural elements of the torsion damper. Accordingly there is no need for an additional wall on the piston, as is known in the above-mentioned prior art. There is also no need for seals on the torsion damper wall, which compensate for the movements of the piston. The torsion damper wall can be fitted simply during the production and assembly of the torsion damper. In summary, thanks to the torsion damper wall the cooling of the bridging clutch can be ensured, while at the same time the converter can be produced inexpensively.

The torsion damper wall can be a separate structural element of the torsion damper, which has no function besides the said function. Thus, the wall is an additional structural element of the damper which is provided in addition to the other structural elements of the damper. Alternatively, the torsion damper wall can fulfill one or more additional functions of the torsion damper, such as the function of supporting one or more further structural elements of the torsion damper.

The torsion damper wall can be arranged on the side of the torsion damper that faces toward the intermediate space. Or else, the torsion damper wall can be arranged on the side of the torsion damper that faces away from the intermediate space.

In particular the torsion damper wall serves for the targeted guiding of the hydraulic fluid through the intermediate space to the bridging clutch. Thus, the bridging clutch can be lubricated and cooled reliably and as necessary by the large amount of hydraulic fluid flowing against it. This guiding of the hydraulic fluid by means of the torsion damper wall is enabled by virtue of appropriate shape and size of the wall.

In particular, in the radially inner area of the intermediate space an inlet opening for the hydraulic fluid is provided. During the operation of the torque converter hydraulic fluid passes through this into the converter in order to lubricate and cool the bridging clutch. The hydraulic fluid flows from the inlet opening inside the intermediate space, radially outward to the bridging clutch. In particular, the torsion damper wall extends radially between the inlet opening and the bridging clutch, in order to guide the hydraulic fluid coming in from the inlet opening radially outward to the bridging clutch. In particular the inlet opening is designed to guide hydraulic fluid admitted from a radially inner driveshaft into the intermediate space. The driveshaft is in particular a transmission input shaft.

It can now be provided that the torsion damper wall seals the intermediate space hermetically for the hydraulic fluid in the direction of the torsion damper. This minimizes any bypass flow of the hydraulic fluid out of the intermediate space through the torsion damper. In that way the greatest possible volume flow of hydraulic fluid reaches the bridging clutch. Sometimes, that demands an elaborate and expensive seal of the torsion damper in the area of the intermediate space.

Alternatively, it can be provided that the torsion damper wall seals the intermediate space incompletely for the hydraulic fluid in the direction of the torsion damper. Thus, a certain bypass flow of the hydraulic fluid out of the intermediate space through the torsion damper is allowed. Then, although the greatest possible volume flow of hydraulic fluid does not get to the bridging clutch, there is no need for an elaborate and expensive seal of the torsion damper wall. In particular it can be provided that at the intermediate space the torsion damper wall only closes off or covers some of many openings of the torsion damper. Thus, the production costs of the converter can be kept low while at the same time sufficient cooling of the bridging clutch is achieved. Moreover, the torsion damper wall can then be particularly light. In particular, the torsion damper wall in such a case is designed such that despite this, most of the hydraulic fluid flowing into the intermediate space via the inlet opening gets to the bridging clutch.

The torsion damper wall can therefore be shaped such that in the intermediate space, most of the hydraulic fluid bypasses the openings of the torsion damper to the bridging clutch, without the wall sealing or covering those openings (completely). This is brought about by a corresponding flow-guiding structure of the torsion damper wall. In other words, the flow in the intermediate space is guided in such manner that most of the hydraulic fluid flowing into it flows past the deliberately unsealed openings of the torsion damper. In this way too, the costs can be kept low while at the same time sufficient cooling of the bridging clutch is achieved.

The torsion damper has an input side and an output side relative to which the rotational irregularities are damped. The input side is in this case formed in particular by one or more first damper disks, for example one or more sheet-metal disks. The output side comprises in particular a hub (torsion damper hub) designed to be coupled rotationally fixed to a driveshaft. In particular, for that purpose the hub can have internal teeth.

In one embodiment of this, the torsion damper wall is suspended on the torsion damper on the input side. In particular, the wall is attached to the damper disk or disks, which is/are associated with the input side. In an alternative embodiment, in contrast, the torsion damper wall is suspended on the output side of the torsion damper. In particular, the wall is then attached to the torsion damper hub. This makes for a simpler structure of the torsion damper.

Preferably, the input side of the torsion damper comprises a supporting element for the bridging clutch. In particular, this supporting element is a supporting element for carrying clutch disks of the bridging clutch. In that case the bridging clutch is in the form of a disk clutch. Thus, the supporting element can be an inner disk carrier or an outer disk carrier of the bridging clutch.

In one embodiment the torsion damper wall is attached to the supporting element. Thus, the supporting element and the torsion damper wall are two different structural elements of the torsion damper, which are solidly connected to one another. In this case the torsion damper wall is in particular welded or riveted to the supporting element. It can also be provided that the torsion damper wall and the supporting element are fixed together onto the rest of the torsion damper. This can be done for example by rivets, which attach the torsion damper wall together with the supporting element to a damper disk of the torsion damper. By making the torsion damper wall and the supporting element as separate components, the production of those components can be simplified. In an embodiment alternative thereto, the torsion damper wall is part of the supporting element. Thus, the two of them form a single, integral structural element of the torsion damper. For example, the torsion damper wall and the supporting element are in the form of a common and correspondingly shaped sheet-metal component. In that way the assembly of the torsion damper can be simplified since it has fewer structural elements.

Preferably, the torsion damper wall is attached by means of rivets. As explained, it can be attached to the torsion damper for example on the input or the output side. For this, it can be provided that the rivets connect rotationally fixed to one another (at least or exactly) two further structural elements of the torsion damper. In particular, these elements are the supporting element and a damper disk of the torsion damper, which are arranged on the inlet side. Alternatively, the structural elements are the torsion damper hub and a turbine wheel of the torque converter, or two damper disks located at the outlet side of the damper. These structural elements are often in any case connected to one another in a rotationally fixed manner by means of rivets. Thus, preferably the only rivets or rivet holes used for attaching the torsion damper wall are ones which are in any case already present. In that way the number of rivets and production steps for the torsion damper can be kept small.

The rivets for attaching the torsion damper wall are in particular arranged on a common circumference or circumferential area of the torsion damper. Further rivets for connecting other structural elements of the torsion damper can be arranged on another circumference or circumferential area of the torsion damper. The first-mentioned circumference or circumferential area can be radially inside or radially outside relative to the other circumference or circumferential area. Thus, the torsion damper wall is only attached on one of several circumferences or circumferential areas.

Preferably, the torsion damper has a plurality of bow springs which are arranged on a first circumference or first circumferential area of the torsion damper. In the area of these first bow springs axial openings are arranged in the torsion damper, through which hydraulic fluid can flow through the torsion damper. The openings are in particular windows, in which the first bow springs are arranged. The torsion damper wall covers these openings at least partially in order to guide the hydraulic fluid coming in from the inlet opening past the openings toward the bridging clutch. For example, it extends radially at least partially over the openings. Thus, the bridging clutch can be arranged in an advantageous position radially outside the first bow springs and the associated openings.

Preferably, the torsion damper has second bow springs which are arranged on a second circumference or second circumferential area of the torsion damper. The second circumference or second circumferential area is in this case radially outside the first circumference or circumferential area. The bridging clutch is now coupled to the torsion damper between the first and second circumferences/circumferential areas. The aforesaid supporting element of the torsion damper is thus in particular fixed to the rest of the torsion damper between the first and second bow springs.

In the area of these second bow springs as well, axial openings are arranged in the torsion damper, through which the hydraulic fluid can flow through the torsion damper. These openings too are windows in which the second bow springs are arranged. It can now be provided that the torsion damper wall does not cover these openings of the second bow springs, i.e. it does not seal them. In particular, for this the radial extension of the torsion damper wall is smaller than the (second) circumference/circumferential area on which those openings are arranged. Or else, the openings can be left open in the torsion damper wall. In particular the torsion damper wall is designed such that it does not guide a flow of the hydraulic fluid beyond the bridging clutch. Thus, a flow resistance for the hydraulic fluid can be reduced, whereby the flow inside the converter is improved.

In particular, the first and/or second bow springs are arranged uniformly distributed around the respectively associated (first or second) circumference/circumferential area. In particular, the input side and the output side of the torsion damper are rotatably connected to one another elastically by the first and/or second bow springs. The torque transmission between the input and output sides of the torsion damper thus takes place by way of the first and/or second bow springs.

In particular, the torque converter has a housing and a pump wheel and a turbine wheel. The torsion damper comprises the input side, and the output side which is torque-fluctuation-damped relative to it. The housing is connected rotationally fixed to the turbine wheel and serves as the inlet to the torque converter. The turbine wheel is arranged rotatably inside the housing and is connected rotationally fixed to the output side of the torsion damper. The output side of the torsion damper serves as the drive output of the torque converter and is designed to be connected rotationally fixed to a radially inner driveshaft, in particular such as a transmission input shaft. The bridging clutch of the converter has an inlet connected rotationally fixed to the housing and an outlet connected rotationally fixed to the input side of the torsion damper. The inlet and outlet of the bridging clutch can optionally be connected to one another in a rotationally fixed manner by moving the aforesaid piston and released from one another so that they can rotate. The torsion damper, the bridging clutch and the piston are in particular also accommodated in the housing, particularly in the area of a front side of the housing. The pump wheel is then arranged in particular in the area of a rear side of the housing.

Optionally a motor vehicle transmission is also proposed, which comprises the proposed hydrodynamic torque converter. The transmission has a transmission input shaft, by means of which a drive input torque is delivered to the transmission. The output of the torque converter is in this case connected rotationally fixed to the transmission input shaft, and in particular the converter is arranged on the transmission input shaft. The motor vehicle transmission can be a multi-stage transmission. The transmission then comprises a plurality of selectable gear ratios by virtue of which in each case a torque applied to the input side can be geared up or down and sent to the transmission drive output. In other words, the hydrodynamic torque converter proposed is specially designed to be arranged in a motor vehicle transmission.

Particular properties and advantages of the present torsion damper wall can be the following:
defined, targeted guiding of hydraulic fluid in the torque converter;
effective cooling of the bridging clutch;
less wear of clutch elements of the bridging clutch;
little aging of the hydraulic fluid;
simple design implementation, in particular when combining with rivet joint present in any case;
production as a deformation component;
only slight demand for extra fitting space and weight;
low production costs.

### BRIEF DESCRIPTION OF THE DRAWINGS

Below, the invention is explained in greater detail with reference to figures showing further preferred embodiments of the invention. The figures show, in each case in schematic form:

FIG. 1: a hydrodynamic torque converter,

FIG. 2: a first embodiment of a hydrodynamic torque converter,

FIG. 3 a second embodiment of a hydrodynamic torque converter,

FIG. 4: a third embodiment of a hydrodynamic torque converter,

FIG. 5: a fourth embodiment of a hydrodynamic torque converter.

### DETAILED DESCRIPTION OF THE PREFERRED EMBODIMENTS

In the figures, the same or at least functionally equivalent components are denoted by the same indexes. For the sake of simplicity, in each case only the upper half of the torque converter 1 is shown. The lower half can be made mirror-symmetrically thereto.

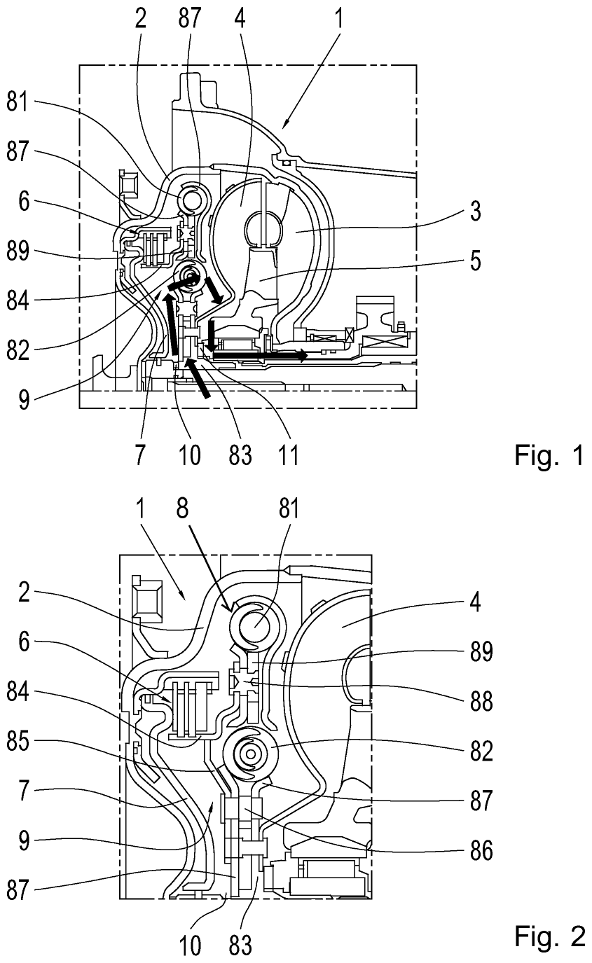

FIG. 1 shows the upper half of a longitudinal section through a hydrodynamic torque converter 1. The converter 1 is for example arranged on the input side of a motor vehicle transmission (none of which is shown). In a manner known as such, the converter 1 comprises a housing 2, a pump wheel 3 and a turbine wheel 4, as well as an optional guide wheel 5. The pump wheel 3 forms the rear area of the housing 2. The pump wheel 3 and the turbine wheel 4 together form a torus, inside which during operation a hydraulic fluid circulates so that a drive torque applied to the housing 2 is transmitted hydrodynamically by the pump wheel 3 to the turbine wheel 4. This principle is known as the Fottinger principle and therefore needs no further explanation.

In the front area of the housing 2 a bridging clutch 6 is provided. This is in the form of a frictional disk clutch. The bridging clutch 6 can be actuated by a hydraulic piston 7 that can be moved in the axial direction. The piston 7 is also accommodated in the front area of the housing 2. By means of the clutch 6, while bypassing the hydrodynamic power branch of the converter 1, drive input torque applied on the input side can be transmitted to the output of the converter 1. Depending on the contact pressure applied to the disks of the clutch 6, a smaller or larger proportion of the transmitted drive input torque is transmitted by the clutch 6 to the output of the converter 1.

Furthermore, in the front area of the converter 1 inside the housing 2 a torsion damper 8 is arranged. The purpose of the damper 8 is to damp or eliminate rotational irregularities of the drive input torque applied to the input side. The damper 8 consists essentially of damper plates 87, a damper disk 89, bow springs 81, 82 and a radially inner torsion damper hub 83. Of the bow springs 81, 82 in each case several are arranged on particular circumferences/circumferential areas of the damper 8. The hub 83 serves at the same time as the output of the damper 8 and the converter 1. It is attached rotationally fixed to a transmission input shaft. The essential structure of such a damper 8 is as such already known and therefore needs no further explanation.

The clutch 6 is connected to the input side of the damper 8, so that a drive input torque transmitted by it is delivered to the damper 8. For this, inner disks of the clutch 6 are arranged rotationally fixed on an inner disk carrier 84, which is part of the input side of the damper 8. The turbine wheel 3, in contrast, is attached directly to the output side of the damper 8, in particular with the hub 83. Thus, the drive input torque delivered by the hydrodynamic power branch of the converter 1 is not damped by the damper 8.

Between the piston 7 and the damper 8 there is an intermediate space 9. Radially on the outside the intermediate space 9 is delimited by the clutch 6. Radially inside the intermediate space 9 there is an inlet opening 10 for hydraulic fluid, which is specifically fed into the converter 1 through the transmission input shaft. This serves both to transmit torque in the hydrodynamic part of the converter 1 and also to cool and lubricate the components of the converter 1. Heat generated during slipping operation of the clutch 6 is therefore dissipated by the hydraulic fluid brought into the intermediate space 9. For this, it is necessary for the hydraulic fluid to flow onto and through the clutch 6.

Conventional torsion dampers 8 have a plurality of axial openings through which the hydraulic fluid can pass almost without loss from one axial side of the damper 8 to the other axial side. Here, there is a risk that a considerable amount of the hydraulic fluid in the intermediate space 9 will not get to the clutch 6, but will pass through the damper 8 as a bypass flow and will make its way to an outlet opening 11 of the converter 1 through openings in the turbine wheel 4. In FIG. 1 such a flow path is indicated schematically by arrows. From this it can be seen that a bypass flow is formed in particular through the openings of the radially inner bow springs 82. Thus, there is a risk that only a small amount of hydraulic fluid will get to the clutch 6. There is a danger of overheating of the clutch 6.

FIGS. 2 to 5 now show various embodiments of hydrodynamic torque converters 1 with proposed options for sufficiently reducing the bypass flow through the damper 8. This is done by means of an additional torsion damper wall 85 provided for the purpose. Thanks to the wall 85 at least most of the hydraulic fluid entering the intermediate space 9 via the inlet opening 10 gets to the clutch 6.

In contrast, the flow of hydraulic fluid on the other side of the clutch 6 is not guided by the wall 85. For that reason the radial extension of the wall 85 is chosen to be correspondingly small. Thus, the passage of hydraulic fluid through the damper 8 in its radially outer area is not impeded by the wall 85. For example, hydraulic fluid can flow unimpeded through openings for the outer bow springs 81.

The walls 85 in FIGS. 2 to 5 are arranged on the side of the damper 8 facing toward the piston 7. However, it is in addition or alternatively possible to arranged a wall 85 that serves the same purpose on the side of the damper 9 facing away from the piston 7. It is true that such an “away-facing” wall 85 cannot guide the hydraulic fluid directly toward the clutch 6, but in this way the flow resistance for the hydraulic fluid through the damper 8 can be increased and the bypass flow can thereby be reduced to a sufficient extent. Thus, in this way too most of the hydraulic fluid in the intermediate space 9 can be led toward the clutch 6.

Below, the differences of the individual solutions from one another and from FIG. 1 will be discussed.

According to FIG. 2, the use of a first embodiment of an additional torsion damper wall 85 is proposed. The wall 85 is suspended on the torsion damper 8 on the output side. For this, the wall 85 is attached by means of rivets 86 to a damper plate 87 of the damper 8. These rivets 86 at the same time serve to connect two output-side damper plates 87 of the damper 8 to one another. Thus, the damper plates 87 and the wall 85 attached thereto are rotation-fluctuation-damped relative to the input side. The rivets 86 are arranged on a common (inner) circumference or circumferential area of the damper 8. They are provided in any case for connecting the two damper plates 87. Thus, no additional steps need to be provided in order to fasten the wall 85.

The wall 85 extends in the radial direction as far as the openings for the radially inner bow springs 82. The wall 85 covers those openings to a sufficient extent. Radially on the outside, the wall 85 is delimited by the supporting element 84. The supporting element 84 is part of the input side of the damper 8. Between the wall 85 and the supporting element 84 a gap is provided, which allows relative rotation between the wall 85 and the supporting element 84. In the gap a seal element can be arranged, in order to prevent the escape of hydraulic fluid out of the intermediate space 9 but allowing the relative movement.

The supporting element 84 is coupled radially between the bow springs 81, 82 to the rest of the damper 8 by means of further rivets 88. In detail, there the supporting element 84 is attached to the damper disk 89 of the damper 8 by means of the rivets 88. This damper disk 89 is located axially between the two damper plates 87. Thus, the supporting element 84 and the damper disk 89 are on the input side of the damper 8. The rivets 88 are arranged on a common (outer) circumference or circumferential area of the damper 8.

In FIG. 2 the wall 85 is saucer-shaped. Preferably, it is made from sheet metal by deformation. It can be provided that the wall has a contour which leads the flow of hydraulic fluid in the intermediate space 9 selectively in the direction toward the clutch 6. The wall can have stiffening ribs or beading. In addition to the openings in the area of the bow springs 82, other openings too in the damper can be fully or partially covered or even sealed by the wall 85.

In FIG. 2 the wall 85 is a separate structural element, which is provided in addition to the other structural elements of the damper 8. In the embodiment according to FIG. 2, besides the function described, namely that of impeding the bypass flow, it has no other function, for example that of supporting other structural elements of the damper 8. But in other embodiments of the proposed wall 85 (not shown), the wall 85 can additionally fulfill other functions. Thus, the wall 85 together with the supporting element 84 can be made integrally and this integral structural element can fulfill several functions.

The use of the wall 85 in accordance with FIG. 2 is particularly suitable for the case when the supporting element 84 has radial openings or bores in the area of the clutch disks of the clutch 6, through which the hydraulic fluid arriving at the clutch 6 can flow from the radial direction onto the clutch disks.

In other respects the explanations relating to FIG. 1 also apply to FIG. 2.

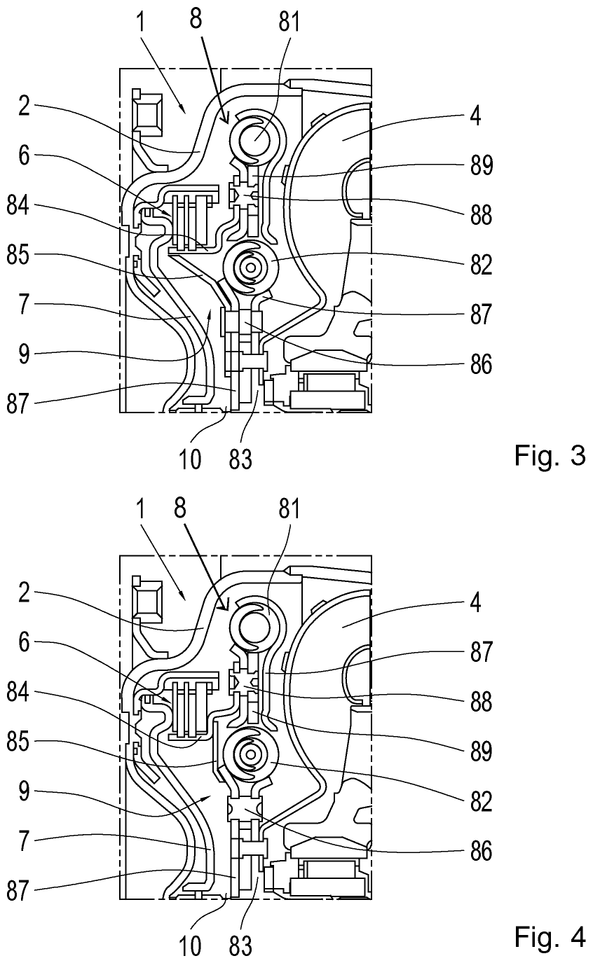

In FIG. 3 a second embodiment of a wall 85 is proposed, which is similar to the one in FIG. 2. Thus, only the differences from the first embodiment in FIG. 2 will be explained.

The wall 85 in FIG. 3 is so shaped that it guides the hydraulic fluid into the gap between the piston 7 and the supporting element 84. For that, the radially outer area of the wall 85 extends from the damper plate 87 on which the wall 85 is fixed, to the gap between the piston 7 and the supporting element 84. Thus, compared with the one in FIG. 2, the wall is rather pot-shaped and has a larger axial extension.

The use of the wall 85 according to FIG. 3 is particularly suitable for the case when the supporting element 84 has no radial openings or bores for the hydraulic fluid in the area of the clutch disks. In that case the hydraulic fluid reaching the clutch 6 flows onto the clutch disks of the clutch 6 from the axial direction.

In other respects the explanations relating to FIGS. 1 and 2 also apply to FIG. 3.

FIG. 4 shows a third embodiment of a wall 85. Otherwise than those of FIGS. 2 and 3, this wall is attached, in particular welded, either radially inside to the damper plate 87 or radially outside to the supporting element 84. Here the wall 85 is a ring or of ring-shaped form. In that way material can be saved. In this case too a gap is provided between the wall 85 and the damper plate 87 or between the wall 85 and the supporting element 84, in order to allow relative movements between the supporting element 84 on the input side and the damper plate 87 on the output side.

In particular in the embodiment according to FIG. 3 there can be openings in the damper 8 which are not covered or sealed by the wall 85 and which therefore allow some bypass flow through the damper 8 in the area of the intermediate space 9. This bypass flow can be tolerated provided that most of the hydraulic fluid in the intermediate space 9 gets to the clutch 6.

In an alternative embodiment of the wall 85 in FIG. 4, the wall 85 is a widened part of the supporting element 84 that projects radially inward. The supporting element 84 and the wall 85 then form a single, integral structural element of the damper 8, with more than one function.

In other respects the explanations relating to FIGS. 1 to 3 also apply to FIG. 4.

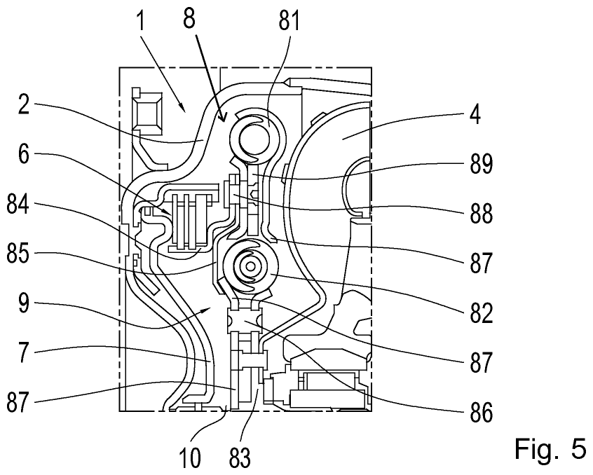

FIG. 5 shows a fourth embodiment of a wall 85. Otherwise than in the walls 85 of the previous figures, this is attached to the damper 8 by the radially outer rivets 88. As already explained in relation to FIG. 2, those rivets 88 at the same time serve to attach the supporting element 84 to the damper disk 87. Thus, in FIG. 5 the wall 85 is attached on the supporting element 84 and suspended on the damper 8 on the input side. Since the rivets 88 are provided in any case for connecting the supporting element 84 to the damper disk 89, no additional steps need to be carried out for attaching the wall 85.

The wall 85 projects radially inward, at least in order to cover the openings for the inner bow springs 82 sufficiently. In that way the bypass flow through the damper 8 in the area of the intermediate space 9 is sufficiently reduced.

Between the wall 85 and the damper plate 87 on that side a gap is provided, which enables relative rotation between those structural elements. In this case too a sealing element can be arranged in the gap to prevent the escape of hydraulic fluid from the intermediate space 9 through the gap, and yet still allow the relative rotations.

In other respects the explanations relating to FIGS. 1 to 4 also apply to FIG. 5.

### INDEXES

1 Torque converter
2 Housing
3 Pump wheel
4 Turbine wheel
5 Guide wheel
6 Bridging clutch
7 Piston
8 Torsion damper
81 Bow spring
82 Bow spring
83 Torsion damper hub; outlet of the torsion damper
84 Supporting element; inner disk carrier; inlet of the torsion damper
85 Torsion damper wall
86 Rivet
87 Damper plate
88 Rivet
89 Damper disk
9 Intermediate space
10 Inlet opening
12 Outlet opening

1-11. (canceled)

12. A hydrodynamic torque converter (1), with a bridging clutch (6) and with a torsion damper (8), and with a piston (7) and with an intermediate space (9) between the piston (7) and the torsion damper (8),
the piston (7) serving to actuate the bridging clutch (6), and
a torsion damper wall (85), by which hydraulic fluid flowing into the intermediate space (9), being guided toward the bridging clutch (6).

13. The hydrodynamic torque converter (1) according to claim 12, wherein the torsion damper wall (85) seals the intermediate space (9), completely or incompletely, in a direction of the torsion damper (8).

14. The hydrodynamic torque converter (1) according to claim 12, wherein the torsion damper (8) has an inlet side (84) and an outlet side (83) which is rotational-irregularity-damped relative thereto, and
the torsion damper wall (85), on the inlet side, is suspended on the torsion damper (8).

15. The hydrodynamic torque converter (1) according to claim 14, wherein the torsion damper (8), on the inlet side (84), has a supporting element (84) for the bridging clutch (6), and
the torsion damper wall (85) is attached to the supporting element (84).

16. The hydrodynamic torque converter (1) according to claim 14, wherein the torsion damper (8), on the inlet side (84), has a supporting element (84) for the bridging clutch (6), and
the torsion damper wall (85) is part of the supporting element (84).

17. The hydrodynamic torque converter (1) according to claim 12, wherein the torsion damper (8) has an inlet side (84) and an outlet side (83) which is rotational-irregularity-damped relative thereto, and
the torsion damper wall (85) is suspended, on the outlet side, on the torsion damper (8).

18. The hydrodynamic torque converter (1) according to claim 12, wherein the torsion damper wall (85) is attached by rivets (86, 88), and
the rivets (86, 88) also connect two further structural elements (87; 84, 89) of the torsion damper (8) to one another in a rotationally fixed manner.

19. The hydrodynamic torque converter (1) according to claim 12, wherein the intermediate space (9) has a radially inner inlet opening (10) for the hydraulic fluid, and
the torsion damper wall (85) extends radially, between the inlet opening (10) and the bridging clutch (6), in order to guide the inflowing hydraulic fluid to the bridging clutch (6).

20. The hydrodynamic torque converter (1) according to claim 19, wherein the torsion damper (8) has first bow springs (81), which are arranged on a first circumference or a first circumferential area of the torsion damper (8),
openings are arranged in the torsion damper (8), in the area of the first bow springs (81), through which hydraulic fluid can flow through the torsion damper (8), and
the torsion damper wall (85) at least partially covers the openings.

21. The hydrodynamic torque converter (1) according to claim 20, wherein the torsion damper (8) has second bow springs (82), which are arranged on a second circumference or a second circumferential area of the torsion damper (8),
the second circumference or the second circumferential area is radially outside relative to the first circumference or the first circumferential area, and
the bridging clutch (6) is radially between the first and the second circumferences or the first and the second circumferential areas and is coupled to the torsion damper (8).

22. The hydrodynamic torque converter (1) according to claim 21, wherein openings are arranged in the torsion damper (8), in an area of the second bow springs (82), through which hydraulic fluid can flow through the torsion damper (8), and
the torsion damper wall (85) is designed such that the torsion damper wall (85) does not cover these openings.

23. A hydrodynamic torque converter (1) comprising:
a bridging clutch (6),
a piston (7) for actuating the bridging clutch (6),
a torsion damper (8),
an intermediate space (9) between located between the piston (7) and the torsion damper (8), and
a torsion damper wall (85), by which hydraulic fluid flowing into the intermediate space (9), being guided toward the bridging clutch (6).
